(19) United States
(12) Patent Application Publication
(10) Pub. No.: US 2021/0081753 A1
(43) Pub. Date: Mar. 18, 2021

(54) REINFORCEMENT LEARNING IN COMBINATORIAL ACTION SPACES

(71) Applicant: GOOGLE LLC, Mountain View, CA (US)

(72) Inventors: Tze Way Eugene IE, Los Altos, CA (US); Vihan JAIN, San Francisco, CA (US); Jing WANG, Sunnyvale, CA (US); Ritesh AGARWAL, Sunnyvale, CA (US); Craig Edgar BOUTILIER, Palo Alto, CA (US)

(73) Assignee: Google LLC, Mountain View, CA (US)

(21) Appl. No.: 16/975,060

(22) PCT Filed: May 20, 2019
(86) PCT No.: PCT/US2019/033141

§ 371 Date: Aug. 21, 2020

Related U.S. Application Data
(60) Provisional application No. 62/673,837, filed on May 18, 2018.

(51) Int. Cl. G06N 3/00; G06N 3/04; G06N 3/08; G06N 3/063; G06K 9/62

(52) U.S. Cl. CPC G06N 3/008; G06N 3/0454; G06K 9/6262; G06N 3/063; G06N 3/08

(57) ABSTRACT

Methods, systems, and apparatus, including computer programs encoded on computer storage media, for reinforcement learning in combinatorial action spaces. One of the methods includes receiving an observation characterizing a current state of an environment; for each of a plurality of candidate actions: processing a network input using a Q neural network to generate a Q value that represents a return received if the candidate action is selected while the candidate action is presented in response to the received observation, processing the network input using a myopic neural network to generate a myopic output that represents a likelihood that the candidate action will be selected if the candidate action is presented in response to the received observation, and combining the myopic output and the Q value for the candidate action to generate a selection score for the candidate action; and selecting the candidate actions having the highest selection scores.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes a reinforcement learning system that, at each time step, selects a set of multiple actions to be presented, e.g., to a user or to a control system, in response to a received observation characterizing the state of an environment.

In particular, at each time step, the system receives an observation characterizing a current state of an environment.

For each of a plurality of candidate actions, e.g., for each possible action or for some subset of the possible actions that includes a large number of actions, the system processes a network input that includes the observation and data characterizing the candidate action using a Q neural network.

The Q neural network is configured to process the network input to generate a Q value that represents a return received if the candidate action is selected while the candidate action is presented in response to the received observation.

The system also processes the network input using a myopic neural network that is configured to process the network input to generate a myopic output that represents a likelihood that the candidate action will be selected if the candidate action is presented in response to the received observation. For example, the myopic output can be a predicted probability of selection of the candidate action.

The myopic neural network and the myopic output are referred to as “myopic” because the myopic output only considers the immediate, short-term response of the user or control system to the presented action without considering the longer-term impact of presenting the action, e.g., whether the user or control system will select the candidate action.

The system then combines the myopic output and the Q value for the candidate action to generate a selection score for the candidate action.

The system selects for inclusion in the set of multiple actions the candidate actions having the highest selection scores.

Thus, the system can select a set of multiple actions without needing to explore the extremely large combinatorial space of possible action sets.

Particular embodiments of the subject matter described in this specification can be implemented so as to realize one or more of the following advantages.

The described systems can effectively select slates of multiple actions even in an extremely large combinatorial action space in a computationally efficient manner. For example, systems can effectively select slates of five or ten actions from a slate that includes ten thousand or a hundred thousand actions. In particular, existing techniques for applying reinforcement learning to settings where multiple actions need to be selected at each time step have been unable to scale to action spaces with large amounts of actions because of the large amount of computational resources required to evaluate the many possible slates that can be drawn from the large action space. By contrast, the described system uses conditional Q values for individual actions in selecting the slate of actions. This allows the system to effectively select a slate of actions in a computationally efficient manner. In particular, this specification describes various techniques to select a high-quality slate of actions using Q values for individual actions in a computationally efficient manner, i.e., in a manner that minimizes the amount of computational resources consumed and latency required to select the slate from a very large space of possible actions.

In some cases, the system can select slates that maximize long-term value, i.e., long-term user satisfaction or an overall, long-term energy use/efficiency. For example, long-term user satisfaction can be measured in whether the user will continue to use and see value in a recommendation service over a long period of time. Moreover, in content recommendation settings, the system can provide high-quality action slates even when the system has a large number, e.g., on the order of millions, of different users having different preferences and characteristics.

When used in controlling a mechanical agent or an industrial facility, the ability to provide a slate of actions from a large body of potential actions in a fast and computationally efficient manner can allow a user or a control system to instruct the mechanical agent or part of the industrial facility to perform desired actions more quickly (e.g. in substantially real time) in response to changes in the environment. For example, if one or more sensors associated with the mechanical agent or part of the industrial facility provide sensor data indicating that a potential fault or undesirable event has occurred or may be about to occur (such as a decrease in energy efficiency or safety), the user is quickly provided with a relevant slate of actions that can allow the fault or undesirable event to be corrected or even avoided altogether.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 shows an example architecture of a Q neural network and a myopic neural network.

FIG. 3 is a flow diagram of one example process for selecting an action slate in response to an observation.

FIG. 4 is a flow diagram of another example process for selecting an action slate in response to an observation.

FIG. 5 is a flow diagram of yet another example process for selecting an action slate in response to an observation.

FIG. 6 is a flow diagram of one example process for training the Q neural network.

FIG. 7 is a flow diagram of another example process for training the Q neural network.

Like reference numbers and designations in the various drawings indicate like elements.

### DETAILED DESCRIPTION

This specification generally describes a reinforcement learning system that selects a slate of actions, i.e., a set of multiple actions, in response to an observation that characterizes the state of an environment and provides the selected action slate to an action selector.

Each slate of actions includes multiple actions from a predetermined space of actions and the action selector interacts with the environment by selecting and performing an action.

The environment generally transitions or changes states in response to actions performed by the action selector. In particular, in response to the action selector performing an action, the environment transitions into a new state and the reinforcement learning system receives a reward. The reward is a numeric value that is a function of the state of the environment. While interacting with the environment, the reinforcement learning system attempts to maximize the long-term reward received in response to the actions performed by the action selector. This long-term reward is also referred to in this specification as a “long-term value.”

In some other implementations, the environment is a real-world environment that is being interacted with by a robot, vehicle, or other mechanical agent and the action selector is an operator or control system of the agent. The state of the environment may be represented in terms of sensor data received from one or more sensors associated with the agent. For example, the agent may be associated with optical sensors, gyroscopic sensors, location detection systems, or any other sensor that provides physical measurements relating to the real-world environment of the agent. In these implementations, the actions in the set of actions are possible control inputs for controlling the agent, with each action in the action slate being a distinct possible control input for the vehicle. The operator or the control system selects and performs an action by submitting one of the possible control inputs to control the agent in response to the observation. In these implementations, the reward is a measure of short-term progress towards completing a task of the agent in response to performing the action.

In some other implementations, the environment is an industrial facility, e.g., an electric grid or a data center, the actions are possible controls for controlling the facility that affect the energy efficiency or performance of the networked system, and the action selector is a control system that selects actions based on different criteria, e.g., safety or energy efficiency or both, or a user that manages the settings for the facility. The state of the environment may be represented in terms of sensor data received from one or more sensors associated with the facility. For example, the facility may be associated with one or more environmental sensors, such as temperature sensors, power sensors, electrical property sensors (i.e. current sensors, voltage sensors etc.) or any other sensor, which provide physical measurements relating to the facility. In these implementations, the reward is a measure of short-term change in the criteria as a result of adopting the control, e.g., a short-term change in energy consumption of the facility after adopting the control and/or a short term change in a measure of safety for the facility.

In some implementations, the environment is a content item presentation setting provided by a content item recommendation system and the action selector is a user of the content item recommendation system. In these implementations, the actions in the set of actions are recommendations of content items, with each action in the action slate being a recommendation of a distinct content item to the user of the content item recommendation system. The user selects and performs an action by selecting a recommendation and viewing the corresponding content item, which can trigger additional recommendations to be provided by the content item recommendation system. In these implementations, the reward is a measure of short-term engagement of the user with the recommendation system after selecting a given content item. For example, the measure of short-term engagement can be a length of time that the user interacted with the selected content item or interacted with the system after selecting the content item.

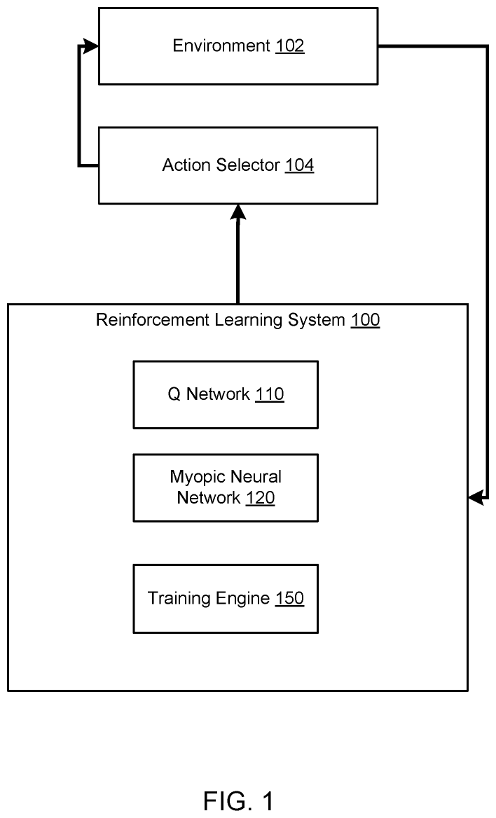

FIG. 1 shows an example reinforcement learning system 100. FIG. 1 shows an example reinforcement learning system 100. The reinforcement learning system 100 is an example of a system implemented as computer programs on one or more computers in one or more locations in which the systems, components, and techniques described below are implemented.

The reinforcement learning system 100 receives observations characterizing states of an environment 102 and, in response to each observation, selects an action slate to be provided to an action selector 104 that selects and performs actions to interact with the environment 102. As described above, the action selector 104 can be a user or a control system that controls the operation of a mechanical agent or an industrial facility. Each action slate includes multiple actions selected from a predetermined space of possible actions. The action slate generally includes only a very small fraction of the actions in the space, e.g., five or ten actions from a space of a thousand, ten thousand, or one hundred thousand actions.

In particular, the reinforcement learning system 100 receives an observation characterizing a current state of the environment 102, selects an action slate that includes multiple actions, and provides the selected action slate to the action selector 104.

Generally, the observation is data characterizing the current state of the environment.

For example, in cases where the environment 102 is a content item presentation setting, the observation may be a high-dimensional feature vector that characterizes the current content item presentation setting. As a particular example, the observation can include user features (e.g., demographics) and a summarization of relevant user history or past behavior (e.g., past action slates seen by the user, content items consumed, degree of engagement of the user, and so on).

As another example, in cases where the environment 102 is a real-world environment, the observation may include an image of the real-world environment and/or other data captured by other sensors of the agent interacting the real-world environment.

The reinforcement learning system 100 selections action slates using a Q neural network 110 and a myopic neural network 120.

The Q neural network 110 is a deep neural network that is configured to process a network input that includes the observation and data characterizing a candidate action to generate a Q value that represents a return received if the candidate action is selected while the candidate action is presented in response to the received observation. Because of the way that the Q neural network 110 is trained, the return represents an estimate of a long-term reward received if the candidate action is selected.

The long-term reward can be, for example, the time-discounted sum of future rewards received by the reinforcement learning system 100 after the observation characterizing the current state of the environment 102 is received if the candidate action is selected.

The data characterizing the action can be, e.g., a one-hot vector that identifies the action or a feature vector that includes certain pre-computed features of the action.

The myopic neural network 120 is a deep neural network that is configured to process the network input to generate a myopic output that represents a likelihood that the candidate action will be selected if the candidate action is presented in response to the received observation. In other words, the myopic output represents the immediate probability that the candidate action will be selected by the action selector if the candidate action is included in the action slate.

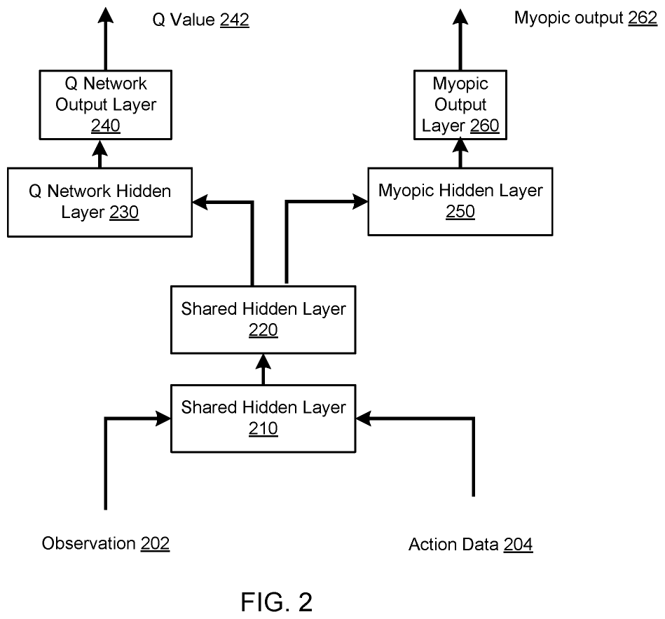

An example architecture of the Q neural network and the myopic neural network are described below with reference to FIG. 2.

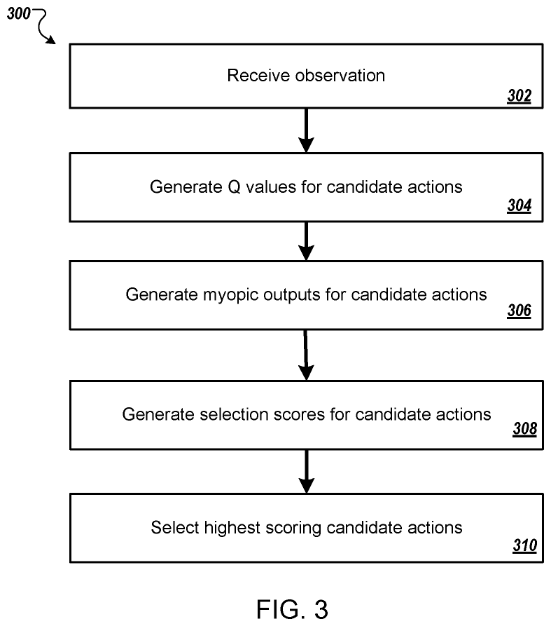

Various techniques for selecting an action slate using the Q neural network and the myopic neural network are described in more detail below with reference to FIG. 3-5.

In order to allow the reinforcement learning system 100 to effectively select action slates to be provided to the action selector 104, the reinforcement learning system 100 includes a training engine 150 that trains the Q neural network 110 and, optionally, the myopic neural network 120 to adjust the values of the parameters of the Q neural network and of the myopic neural network from initial values of the parameters.

In particular, during the training, the training engine 150 receives training transitions generated as a result of providing action slates to the action selector 104 and uses the received training transitions to update the values of the parameters of the Q neural network or of both neural networks.

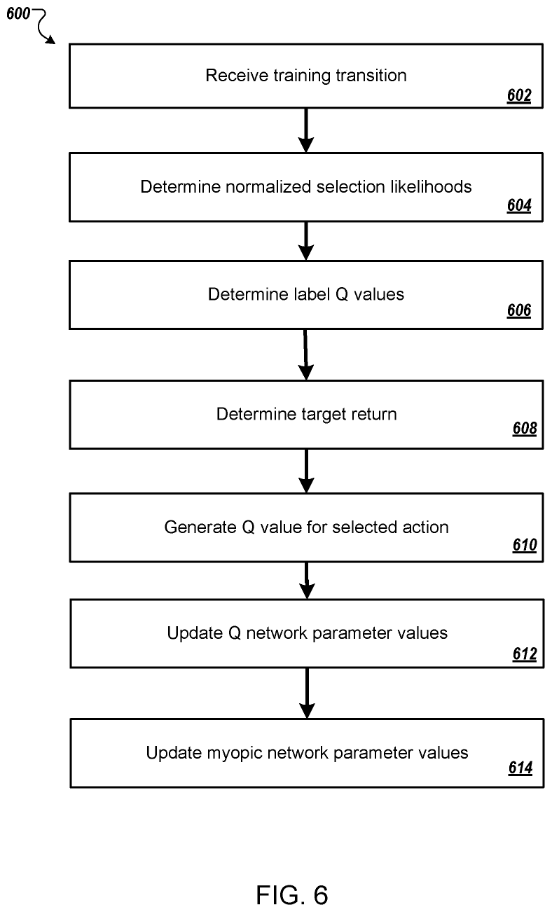

In some implementations, each training transition includes a current observation, a current slate of actions that was presented in response to the current observation, data identifying the action from the current slate that was selected by the action selector, data identifying a short-term reward for the first action, a next observation characterizing the state that environment transitioned into as a result of the action selection, and a next slate of actions that was presented in response to the next observation. Training the Q neural network and, optionally, the myopic neural network on these kinds of training transitions is described below with reference to FIG. 6.

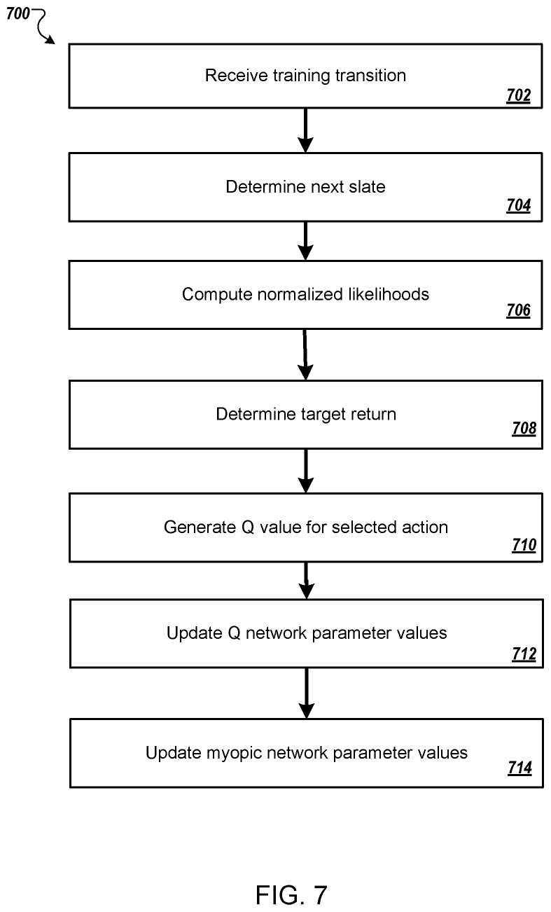

In some other implementations, each training transition includes a current observation, a current slate of actions that was presented in response to the current observation, data identifying the action from the current slate that was selected by the action selector, data identifying a short-term reward for the first action, and a next observation characterizing the state that environment transitioned into as a result of the action selection. Training the Q neural network on these kinds of training transitions is described below with reference to FIG. 7.

FIG. 2 shows an example architecture of the Q neural network and the myopic neural network.

In the example of FIG. 2, the Q neural network and the myopic neural network share parameter values and both receive an observation 202 and action data 204 characterizing an action.

In particular, both neural networks include the same two shared hidden layers: a shared hidden layer 210 and a shared hidden layer 220. The shared hidden layer 210 can be a fully-connected layer that operates on a concatenation of the observation 202 and the action data 204. Similarly, the hidden layer 220 can be a fully-connected layer that operates on the output of the shared hidden layer 210. When the observations include images, the shared hidden layers can be convolutional layers instead of fully-connected layers.

The Q neural network includes a Q network hidden layer 230 and a Q network output layer 240 that generates a Q value 242. The Q network hidden layer 230 can be a fully-connected layer that operates on the output of the shared hidden layer 220 and the Q network output layer can be a layer with a single, fully-connected neuron that generates the Q value 242 from the output of the Q network hidden layer 230.

The myopic neural network includes a myopic hidden layer 250 and a myopic output layer 260 that generates a myopic output value 262, e.g., a probability. The myopic hidden layer 250 can be a fully-connected layer that operates on the output of the shared hidden layer 220 and the myopic output layer can be a layer with a single, fully-connected neuron that generates the myopic output 262 from the output of the myopic hidden layer 250.

Because the layers 210 and 220 are shared between the two architectures, updates generated as a result of training the Q network are applied to the parameter values of the Q network output layer, the Q network hidden layer, and the shared layers, while updates generated as a result of training the myopic network are applied to the parameter values of the myopic output layer, the myopic hidden layer, and the shared layers.

In other implementations, the Q network and the myopic neural network may be separate neural networks such that the two neural networks would not share any parameters. In these implementations, the myopic neural network may be pre-trained, i.e., the parameter values used to generate myopic outputs are an input to the system and are not generated by the system, or the system may train the two neural networks jointly.

FIG. 3 is a flow diagram of an example process 300 for selecting an action slate in response to a received observation. For convenience, the process 300 will be described as being performed by a system of one or more computers located in one or more locations. For example, a reinforcement learning system, e.g., the reinforcement learning system 100 of FIG. 1, appropriately programmed in accordance with this specification, can perform the process 300.

The system receives an observation characterizing the current state of the environment (step 302).

For each of a plurality of candidate actions, the system processes the observation and data characterizing the candidate action using the Q neural network to generate a Q value that represents a return received if the candidate action is selected while the candidate action is presented in response to the received observation (step 304).

In some cases, the plurality of candidate actions is all of the actions in the space of possible actions. In other cases, the plurality of candidate actions is a subset of the space of possible actions, i.e., a proper subset of the space that nonetheless is significantly larger than the number of items in the slate. For example, the system or an external process not under the control of the system can perform some pre-processing to filter out actions from the space that are infeasible given the current state of the environment, e.g., actions that are not safe to perform given the current state of the environment or actions that have been previously deprecated by the action selector.

For each of the plurality of candidate actions, the system processes the network input using the myopic neural network to generate a myopic output that represents a likelihood that the candidate action will be selected if the candidate action is presented in response to the received observation (step 306).

When the Q network and the myopic neural network share parameters as described above, the system can perform steps 304 and 306 for a given candidate action in a single forward pass through the neural network. Moreover, by employing batching of inputs, parallel processing or both, the system can efficiently perform steps 304 and 306 for all of the candidate actions in the space in a very resource and time efficient manner even when the space is very large. In particular, because the Q value and myopic output for a given candidate action do not depend on any other action, the system can effectively parallelize the processing of steps 304 and steps 306 so that a very large space of candidate actions can be evaluated with minimal latency.

For each of the plurality of candidate actions, the system generates a selection score from the Q value for the action and the myopic output for the action (step 308). In particular, the system combines, e.g., multiplies, the Q value for the action and the myopic output for the action to generate the selection score.

The system selects for inclusion in the slate the candidate actions having the highest selection scores (step 310). In other words, the system selects an action slate that includes the k actions with the highest selection scores, where k is the total number of actions to be presented to the action selector.

The system then presents the action slate to the action selector or provides the action slate for presentation to the action selector, e.g., over a data communication network when the system is implemented remotely from the action selector.

In implementations where the actions are presented in an order within the slate, the system can order the actions by selection score or by Q value within the slate for presentation to the action selector. Ordering the actions by Q value, i.e., without considering likelihood of selection, can guide the action selector to selecting actions that maximize long-term reward.

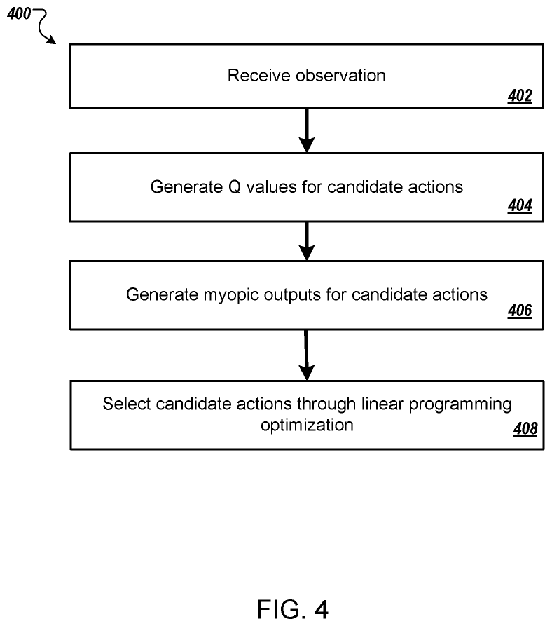

FIG. 4 is a flow diagram of another example process 400 for selecting an action slate in response to a received observation. For convenience, the process 400 will be described as being performed by a system of one or more computers located in one or more locations. For example, a reinforcement learning system, e.g., the reinforcement learning system 100 of FIG. 1, appropriately programmed in accordance with this specification, can perform the process 400.

The system receives an observation characterizing the current state of the environment (step 402).

For each of the plurality of candidate actions, the system processes the observation and data characterizing the candidate action using the Q neural network to generate a Q value that represents a return received if the candidate action is selected while the candidate action is presented in response to the received observation (step 404).

For each of the plurality of candidate actions, the system processes the network input using the myopic neural network to generate a myopic output that represents a likelihood that the candidate action will be selected if the candidate action is presented in response to the received observation (step 406).

In some implementations, the system also processes a network input that includes the next observation and data characterizing a null action using the myopic neural network to generate a myopic output for the null action. The null action is an action that has been designated to represent the action selector not selecting any of the actions in the slate, e.g., because the action selector is dissatisfied with all of the actions or because the action selector terminates a session with the system without making any more selections. Thus the myopic output for the null action represents the likelihood that the action selector does not immediately select any of the presented next actions.

As described above, when the Q network and the myopic neural network share parameters as described above, the system can perform steps 404 and 406 for a given candidate action in a single forward pass through the neural network. Moreover, by employing batching of inputs, parallel processing or both, the system can efficiently perform steps 404 and 406 for all of the candidate actions in the space in a very resource and time efficient manner even when the space is very large. In particular, because the Q value and myopic output for a given candidate action do not depend on any other action, the system can effectively parallelize the processing of steps 404 and steps 406 so that a very large space of candidate actions can be evaluated with minimal latency.

The system selects the candidate actions to be included in the slate through linear programming optimization (step 408).

In particular, the system solves, using conventional linear programming optimization techniques, the following linear program (LP) to find the optimal solution (y*, t*):

$$max {\sum }_{i} {y}_{i} v ( s , i ) \overline{Q} ( s , i )$$

$$s . t . tv ( s , ⊥ ) + {\sum }_{i} {y}_{i} v ( s , i ) \overline{Q} ( s , i ) = 1$$

$$t \geq 1 ; \sum {y}_{i} \leq k t ; 0 \leq {y}_{i} \leq t , ∀ i ∈ ℐ$$

where the sum is a sum over the plurality of candidate actions i, v(s,i) is the myopic output for action i, Q̅(s, i) is the Q value for action i, v(s, ⊥) is the myopic output for the null action, and k is the total number of actions in the slate.

The solution y* to this LP includes a respective value yᵢ for each of the candidate actions i. The system then adds to the slate each action i for which yᵢ is greater than zero. Because of the construction of the LP above, the solution y* to the LP is guaranteed to have exactly k non-zero values.

The system then presents the action slate to the action selector or provides the action slate for presentation to the action selector, e.g., over a data communication network when the system is implemented remotely from the action selector.

In implementations where the actions are presented in an order within the slate, the system can order the actions by selection score or by Q value within the slate for presentation to the action selector. Ordering the actions by Q value, i.e., without considering likelihood of selection, can guide the action selector to selecting actions that maximize long-term reward.

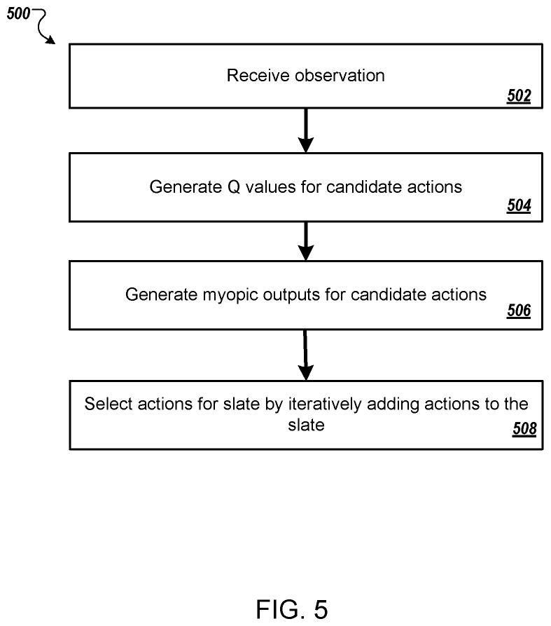

FIG. 5 is a flow diagram of another example process 500 for selecting an action slate in response to a received observation. For convenience, the process 500 will be described as being performed by a system of one or more computers located in one or more locations. For example, a reinforcement learning system, e.g., the reinforcement learning system 100 of FIG. 1, appropriately programmed in accordance with this specification, can perform the process 500.

The system receives an observation characterizing the current state of the environment (step 502).

For each of the plurality of candidate actions, the system processes the observation and data characterizing the candidate action using the Q neural network to generate a Q value that represents a return received if the candidate action is selected while the candidate action is presented in response to the received observation (step 504).

For each of the plurality of candidate actions, the system processes the network input using the myopic neural network to generate a myopic output that represents a likelihood that the candidate action will be selected if the candidate action is presented in response to the received observation (step 506).

In some implementations, the system also processes a network input that includes the next observation and data characterizing the null action using the myopic neural network to generate a myopic output for the null action.

As described above, when the Q network and the myopic neural network share parameters as described above, the system can perform steps 504 and 506 for a given candidate action in a single forward pass through the neural network. Moreover, by employing batching of inputs, parallel processing or both, the system can efficiently perform steps 504 and 506 for all of the candidate actions in the space in a very resource and time efficient manner even when the space is very large. In particular, because the Q value and myopic output for a given candidate action do not depend on any other action, the system can effectively parallelize the processing of steps 504 and steps 506 so that a very large space of candidate actions can be evaluated with minimal latency.

The system selects the candidate actions to be included by iteratively adding actions to the slate one by one using the myopic outputs and the Q values (step 508). In particular, given a partial slate that includes L items (where L is less than the total size of the slate k) the system adds to the slate the action from the plurality of candidate actions that has the maximum marginal contribution. The action i with the maximum marginal contribution is the action with the index i that satisfies:

$${arg max}_{i ∉ {A}^{′}} \frac{v ( s , i ) \overline{Q} ( s , i ) + {\sum }_{𝓁 \leq L} v ( s , {i}_{( 𝓁 )} ) \overline{Q} ( s , {i}_{( 𝓁 )} )}{v ( s , i ) + v ( s , ⊥ ) + {\sum }_{𝓁 \leq L} v ( s , {i}_{( 𝓁 )} )} .$$

where A′ is the set of actions from the plurality of actions that are not already in the slate, v(s,i) is the myopic output for action i, Q̅(s,i) is the Q value for action i the sum is a sum over the L actions already in the slate, v(s,i₍ₗ₎) is the myopic output for action l that is already in the slate, Q̅(s,i₍ₗ₎) is the Q value for action l, and v(s, ⊥) is the myopic output for the null action.

Thus, the system fills the slate by repeatedly adding the action that has the maximum marginal contribution of the actions that are not yet in the slate.

The system then presents the action slate to the action selector or provides the action slate for presentation to the action selector, e.g., over a data communication network when the system is implemented remotely from the action selector.

In implementations where the actions are presented in an order within the slate, the system can order the actions by selection score or by Q value within the slate for presentation to the action selector. Ordering the actions by Q value, i.e., without considering likelihood of selection, can guide the action selector to selecting actions that maximize long-term reward.

FIG. 6 is a flow diagram of an example process 600 for training the Q neural network and the myopic neural network. For convenience, the process 600 will be described as being performed by a system of one or more computers located in one or more locations. For example, a reinforcement learning system, e.g., the reinforcement learning system 100 of FIG. 1, appropriately programmed in accordance with this specification, can perform the process 600.

The system can repeatedly perform the process 600 on multiple different training transitions to train the two neural networks, i.e., to determine trained values of the parameters of the two neural networks from initial values of the parameters.

The system receives a training transition (step 602). As described above, each training transition generally includes a current observation, a current slate of actions that was presented in response to the current observation, data identifying a selected action, i.e., the action from the current slate that was selected by the action selector, data identifying a short-term reward for the first action, a next observation characterizing the state that environment transitioned into as a result of the action selection, and a next slate of actions that was presented in response to the next observation. The actions in the next slate will be referred to as “next actions.”

The system determines a respective normalized predicted selection likelihood for each next action in the next slate of actions using the myopic neural network (step 604).

In particular, for each next action in the next set of actions, the system processes a network input that includes the next observation and data characterizing the next action using the myopic neural network to generate a myopic output for the action.

In some implementations, the system also processes a network input that includes the next observation and data characterizing the null action using the myopic neural network to generate a myopic output for the null action.

The system then determines the normalized likelihood as the myopic output for the next action divided by the sum of the myopic outputs for all of the next actions in the next slate of actions (and, when used, the myopic output for the null action).

The system determines a respective Q value for each next action in the next set of actions (step 606).

To determine the Q value for a given next action in the next set of actions, the system processes a network input that include the next observation and data characterizing the next action using the Q neural network.

In some implementations, to determine these Q values, the system uses a label Q neural network. The label Q neural network is a neural network that has the same architecture as the Q neural network but whose parameters are updated more slowly during training than the Q neural network. Thus, at any given point in time, the Q neural network parameter values may be different from the label Q neural network parameter values. For example, the system can update the label Q network parameter values to match those of the Q network parameter values only after every N training iterations, where N is a fixed integer greater than one.

Since the label Q network has the same architecture as the Q network, the output of the label Q network is also a Q value, but the Q values generated by the label Q network will change more slowly than those generated by the Q network. This can improve the stability of the training process.

The system determines a target return, i.e., a target long-term reward, from the short-term engagement reward, the normalized predicted selection likelihoods, and the Q values (step 608). In particular the system can determine, for each next action in the next slate, a next selection score by computing the product of the normalized likelihood for the next action and the Q value for the next action. The system can then sum the next selection scores and determine the target long-term return as the sum of the short-term engagement reward and the product of a discount factor and the sum of the next selection scores. Thus, the target return accounts for not only a short-term, myopic reward but also a bootstrapped estimate of a longer-term reward.

The system processes a network input including the current observation and data characterizing the selected action using the Q network to generate a Q value for the selected action (step 610).

The system updates the values of the Q network by computing a gradient of an error between the Q value for the selected action and the target return (step 612). In particular the system determines, by applying a supervised learning training algorithm to the error, an update to the parameters that reduces the error between the Q value and the target return. Thus, the system trains the Q network to generate Q values that reflect long-term rewards rather than short-term, myopic rewards.

Optionally, i.e., only when the myopic neural network is being trained jointly with the Q network, the system updates the values of the myopic neural network (step 614). In particular, the system trains the myopic neural network to predict that the selected action would be selected when presented in response to the current observation and that the other actions in the current action slate would not be selected. In other words, the system determines a parameter update using the current observation—selected action pair as a positive example and the current observation—other action pairs as negative examples.

FIG. 7 is a flow diagram of an example process 700 for training the Q neural network and the myopic neural network. For convenience, the process 700 will be described as being performed by a system of one or more computers located in one or more locations. For example, a reinforcement learning system, e.g., the reinforcement learning system 100 of FIG. 1, appropriately programmed in accordance with this specification, can perform the process 700.

The system can repeatedly perform the process 700 on multiple different training transitions to train the Q neural network.

The system receives a training transition (step 702). Each training transition generally includes a current observation, a current slate of actions that was presented in response to the current observation, data identifying a selected action, i.e., the action from the current slate that was selected by the action selector, data identifying a short-term reward for the first action, and a next observation characterizing the state that environment transitioned into as a result of the action selection.

The system determines a next slate of actions to be provided in response to the next observation (step 704). In particular, the system determines the next slate to be provided using one of the techniques described above with reference to FIGS. 3-5. In some cases, the system uses one of the techniques described above but uses the label Q neural network to generate the Q values that are used in selecting the actions to be in the next slate.

The system computes normalized predicted likelihoods for the action in the next slate as described above (step 706).

The system determines a target return, i.e., a target long-term reward, from the short-term engagement reward and the normalized predicted selection likelihoods and Q values for the next actions in the next slate (step 708). In particular the system can determine, for each next action in the next slate, a next selection score by computing the product of the normalized likelihood for the next action and the label Q value for the next action. The system can then sum the next selection scores and determine the target long-term return as the sum of the short-term engagement reward and the product of a discount factor and the sum of the next selection scores. Thus, the target return accounts for not only a short-term, myopic reward but also a bootstrapped estimate of a longer-term reward.

The system processes a network input including the current observation and data characterizing the selected action using the Q network to generate a Q value for the selected action (step 710).

The system updates the values of the Q network by computing a gradient of an error between the Q value for the selected action and the target return (step 712). In particular the system determines, by applying a supervised learning training algorithm to the error, an update to the parameters that reduces the error between the Q value and the target return. Thus, the system trains the Q network to generate Q values that reflect long-term rewards rather than short-term, myopic rewards.

Optionally, the system updates the values of the myopic neural network (step 714). In particular, the system trains the myopic neural network to predict that the selected action would be selected when presented in response to the current observation and that the other actions in the current action slate would not be selected. In other words, the system determines a parameter update using the current observation—selected action pair as a positive example and the current observation—other action pairs as negative examples.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, .e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of selecting a set of multiple actions for presentation in response to a received observation, the method comprising:
receiving an observation characterizing a current state of an environment;
for each of a plurality of candidate actions:
processing a network input comprising the observation and data characterizing the candidate action using a Q neural network, wherein the Q neural network is configured to process the network input to generate a Q value that represents a return received if the candidate action is selected while the candidate action is presented in response to the received observation,
processing the network input using a myopic neural network, wherein the myopic neural network is configured to process the network input to generate a myopic output that represents a likelihood that the candidate action will be selected if the candidate action is presented in response to the received observation, and
combining the myopic output and the Q value for the candidate action to generate a selection score for the candidate action; and
selecting for inclusion in the set of multiple actions the candidate actions having the highest selection scores.

2. The method of claim 1, wherein combining the myopic output and the Q value for the candidate action to generate a selection score for the candidate action comprises multiplying the myopic output and the Q value.

3. The method of claim 1, wherein the myopic neural network and the Q neural network share some parameters.

4. The method of claim 1, wherein the environment is an industrial facility, wherein the actions are possible controls for controlling the industrial facility, and wherein the set of actions are presented to an operating user or to a control system of the industrial facility as candidate controls for controlling the industrial facility.

5. The method of claim 1, wherein the environment is an environment being interacted with a robot, wherein the actions are possible controls for controlling the robot, and wherein the set of actions are presented to a control system of the robot for selection as control inputs to the robot.

6. The method of claim 1, wherein the environment is a content item recommendation environment, wherein the actions are recommendations of content items, and wherein the set of actions is presented to a user as a set of content item recommendations.

7. The method of claim 6, wherein the observation is features of the user, comprising features characterizing a user history of interactions with the content item recommendation environment, and wherein the data characterizing the candidate action is features of the content item recommended by the candidate action.

8. The method of claim 1, wherein the return is an estimate of a long-term value if the candidate action is selected while the candidate action is presented in response to the received observation.

9. The method of claim 1, wherein the set of actions is presented to a user, and wherein the return is an estimate of long-term user satisfaction.

10. The method of claim 1, further comprising training the Q neural network, comprising:
obtaining a training transition, the training transition comprising:
a current observation,
a current set of actions that was presented in response to the current observation,
data identifying that a first action in the current set was selected,
data identifying a short-term reward for the first action;
a next observation, and
a next set of actions that was presented in response to the next observation;
determining a normalized predicted selection likelihood for each action in the next set of actions using the myopic neural network;
determining a respective Q value for each action in the next set of actions;
determining a target long-term return from the short-term reward, the normalized predicted selection likelihood, and the respective Q values; and
determining an update to the parameters of the Q neural network using the target long-term return.

11. The method of claim 10, wherein determining the respective Q values comprises determining the Q values using a label Q network that has the same architecture but different parameter values from the Q neural network.

12. The method of claim 10, further comprising:
training the myopic neural network to predict that the first action would be selected when presented in response to the current observation.

13. The method of claim 10, wherein
determining the update to the parameters of the Q neural network comprises:
processing a training network input comprising the current observation and data characterizing the first action using the Q neural network to generate a Q value for the first action; and
training the Q neural network to reduce an error between the Q value for the first action and the target long-term return.

14. One or more non-transitory computer-readable readable storage media storing instructions that when executed by one or more computers cause the one or more computers to perform operations for selecting a set of multiple actions for presentation in response to a received observation, the operations comprising:
receiving an observation characterizing a current state of an environment;
for each of a plurality of candidate actions:
processing a network input comprising the observation and data characterizing the candidate action using a Q neural network, wherein the Q neural network is configured to process the network input to generate a Q value that represents a return received if the candidate action is selected while the candidate action is presented in response to the received observation,
processing the network input using a myopic neural network, wherein the myopic neural network is configured to process the network input to generate a myopic output that represents a likelihood that the candidate action will be selected if the candidate action is presented in response to the received observation, and
combining the myopic output and the Q value for the candidate action to generate a selection score for the candidate action; and
selecting for inclusion in the set of multiple actions the candidate actions having the highest selection scores.

15. A system comprising one or more computers and one or more storage devices storing instructions that when executed by the one or more computers cause the one or more computers to perform operations for selecting a set of multiple actions for presentation in response to a received observation, the operations comprising:
receiving an observation characterizing a current state of an environment;
for each of a plurality of candidate actions:
processing a network input comprising the observation and data characterizing the candidate action using a Q neural network, wherein the Q neural network is configured to process the network input to generate a Q value that represents a return received if the candidate action is selected while the candidate action is presented in response to the received observation,
processing the network input using a myopic neural network, wherein the myopic neural network is configured to process the network input to generate a myopic output that represents a likelihood that the candidate action will be selected if the candidate action is presented in response to the received observation, and
combining the myopic output and the Q value for the candidate action to generate a selection score for the candidate action; and
selecting for inclusion in the set of multiple actions the candidate actions having the highest selection scores.

16. The system of claim 15, wherein combining the myopic output and the Q value for the candidate action to generate a selection score for the candidate action comprises multiplying the myopic output and the Q value.

17. The system of claim 15, wherein the myopic neural network and the Q neural network share some parameters.

18. The system of claim 15, the operations further comprising training the Q neural network, comprising:
obtaining a training transition, the training transition comprising:
a current observation,
a current set of actions that was presented in response to the current observation,
data identifying that a first action in the current set was selected,
data identifying a short-term reward for the first action;
a next observation, and
a next set of actions that was presented in response to the next observation;
determining a normalized predicted selection likelihood for each action in the next set of actions using the myopic neural network;
determining a respective Q value for each action in the next set of actions;
determining a target long-term return from the short-term reward, the normalized predicted selection likelihood, and the respective Q values; and
determining an update to the parameters of the Q neural network using the target long-term return.

19. The system of claim 18, wherein determining the respective Q values comprises determining the Q values using a label Q network that has the same architecture but different parameter values from the Q neural network.

20. The system of claim 18, the operations further comprising: training the myopic neural network to predict that the first action would be selected when presented in response to the current observation.
